(19) United States
(12) Patent Application Publication
(10) Pub. No.: US 2011/0124209 A1
(43) Pub. Date: May 26, 2011

(54) Converter

(75) Inventor: Chin Yuan Wu, Taipei (TW)

(73) Assignee: MOXA INC., Taipei (TW)

(21) Appl. No.: 12/591,569

(22) Filed: Nov. 24, 2009

(51) Int. Cl. H01R 12/00

(52) U.S. Cl. 439/75

(57) ABSTRACT

This specification discloses a converter whose first electrical connector of a first standard is fixed on a first circuit board and whose second electrical connector of a second standard is connected to a second circuit board. The second circuit board is thus electrically connected to the first circuit board. Therefore, the converter expands the second connector to the first circuit board. This achieves the goal of connecting circuit boards of different connecting designs.

### BACKGROUND OF THE INVENTION

1. Field of Invention

This invention relates to a converter and, in particular, to a converter that performs internal conversion between a first circuit board and a second circuit board of different connecting designs.

2. Related Art

The industrial personal computer (IPC) is designed exclusively for the industries. In comparison with personal computers (PC's) that are used by common people, the IPC is a largely enhanced PC for industrial controls. It satisfies the reliability requirements in an industrial environment.

Since the IPC is more reliable, has more software support, and is cheaper in price, it has become very popular nowadays. Currently, the IPC's have been widely used in communications, industrial automation, medication, environmental protection, aerospace controls and various aspects of human life.

To meet engineering requirements, some hardware parts of the IPC are enhanced. For different needs, its functions may be expanded. Generally speaking, the IPC is added with a second circuit board, which does not only enhance the functions of the IPC but also provide additional functions.

However, for the second circuit board with some special input/output (I/O) specifications, it is often incompatible with the existing I/O specifications of the first circuit board in the IPC. This is the most serious trouble when the first circuit board of the IPC is added with a second circuit board with special I/O specifications. According to the existing technology, each I/O pin of the I/O specifications of the first circuit board in the IPC is electrically connected to each I/O pin of the second circuit board with the special I/O specifications by wires. This is how the second circuit board with the special I/O specifications can be added into the IPC.

However, this requires manual operations and therefore is not suitable for mass production. Besides, such electrical connections by wires either cannot be fixed or requires additional fixing between the first circuit board and the second circuit board. This introduces new problems to adding the second circuit board to the first circuit board in the IPC. The most fundamental solution is of course to redesign the first circuit board so that the second circuit board with the special I/O specifications can be directly connected. However, the customized design can easily increase the developing cost of the IPC. It is obviously not a good solution.

In summary, the prior art always has the problem that when the connecting designs are different between the first circuit board and the second circuit board, it is difficult to electrically connect them in the IPC. It is thus imperative to provide a solution.

### SUMMARY OF THE INVENTION

In view of the foregoing, the invention discloses a converter. According to a first embodiment of the invention that enables internal conversion between a first circuit board and a second circuit board of different electrical connection designs includes: a housing, a set of first pins, a set of second pins, and a pivotal axis.

The housing consists of a first housing and a second housing. The first housing is constructed by covering a second assembly housing by a first assembly housing. The first assembly housing further has several first configuring holes. The second assembly housing further has several second configuring holes.

The set of first pins has a first electrical connection interface. The set of first pins consists of a first inner electrical connection element and a first outer connection element. The first inner electrical connection element is disposed in the second assembly housing. The first outer electrical connection element protrudes from the first configuring holes. The first outer electrical connection element has an electrical connection with the second circuit board.

The set of second pins has a second electrical connection interface. The set of second pins has a second inner electrical connection end and a second outer electrical connection end. The second inner electrical connection end is disposed in the second housing. The second outer electrical connection end protrudes from the second configuring holes. The second outer electrical connection end forms an electrical connection with the first circuit board. The second inner electrical connection end forms an electrical connection with the first inner electrical connection element according to the electrical connection specifications in the housing.

The pivotal axis penetrates through the second assembly housing, the second housing, the first inner electrical connection element, and the second inner electrical connection end, so that the second housing can rotate with respect to the first housing.

A second embodiment of the disclosed converter is applicable to the internal conversion between a first circuit board and a second circuit board of different electrical connection specifications. It includes: a housing, a set of first pins, and a set of second pins.

The housing has a first surface and a second surface. The first surface has several first configuring holes, and the surface has several second configuring holes.

The set of first pins has a first end and a second end. They are partially enclosed by the housing. The first end protrudes from the first configuring holes, and the second end protrudes from the second configuring holes.

The set of second pins selectively protrude from the first configuring holes, forming with the set of first pin on the first end a first electrical connection interface electrically connected with the second circuit board. The set of first pins on the second end forms a second electrical connection interface electrically connected with the first circuit board. Alternatively, the set of second pins can selectively protrude from the second configuring holes, forming a second electrical connection interface electrically connected with the first circuit board via the set of first pins. The set of first pins on the first end forms a first electrical connection interface electrically connected with the second circuit board.

The converter disclosed above differs from the prior art in that the invention provides an internal conversion between circuit boards with different electrical connection designs. The first electrical connection specification of the converter is fixed on the first circuit board. The second electrical connection specification thereof is connected to the second circuit board. Therefore, the second circuit board is electrically connected to the first circuit board, expanding the functions of the first circuit board. This technique achieves the goal of connecting circuit boards of different electrical connection designs and expanding the functions thereof.

### BRIEF DESCRIPTION OF THE DRAWINGS

The invention will become more fully understood from the detailed description given herein below illustration only, and thus is not limitative of the present invention, and wherein:

FIG. 1 is a three-dimensional exploded view of the first embodiment of the invention;

FIG. 2 is a three-dimensional view of the first embodiment of the invention;

FIG. 3 is a three-dimensional perspective view of the second embodiment of the invention;

FIGS. 4A to 4C are schematic views showing the actions of the first embodiment in use;

FIG. 5A is a three-dimensional view of the second embodiment in its first state; and

FIG. 5B is a three-dimensional view of the second embodiment in its second state.

### DETAILED DESCRIPTION OF THE INVENTION

The present invention will be apparent from the following detailed description, which proceeds with reference to the accompanying drawings, wherein the same references relate to the same elements.

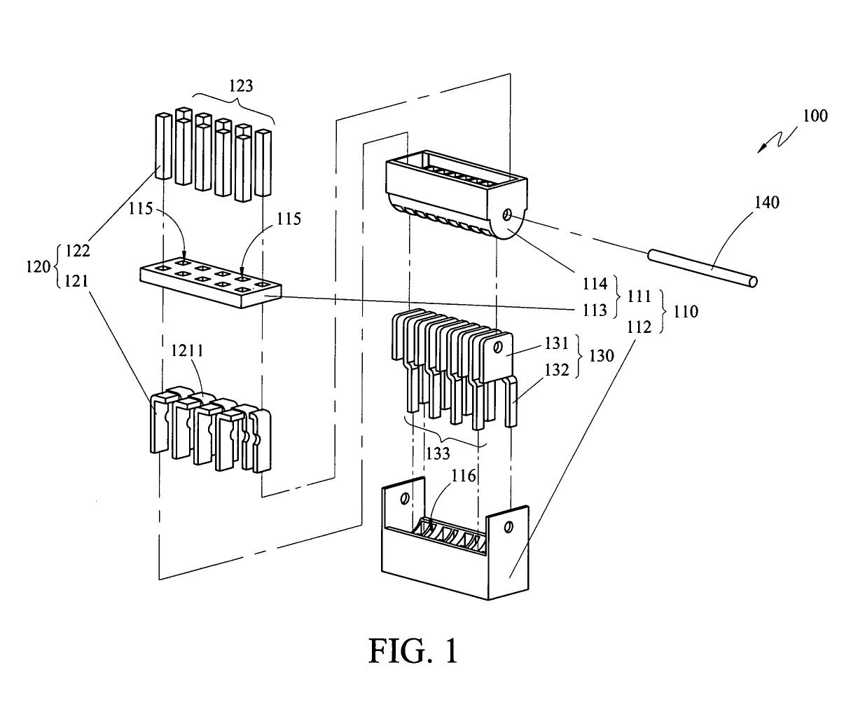

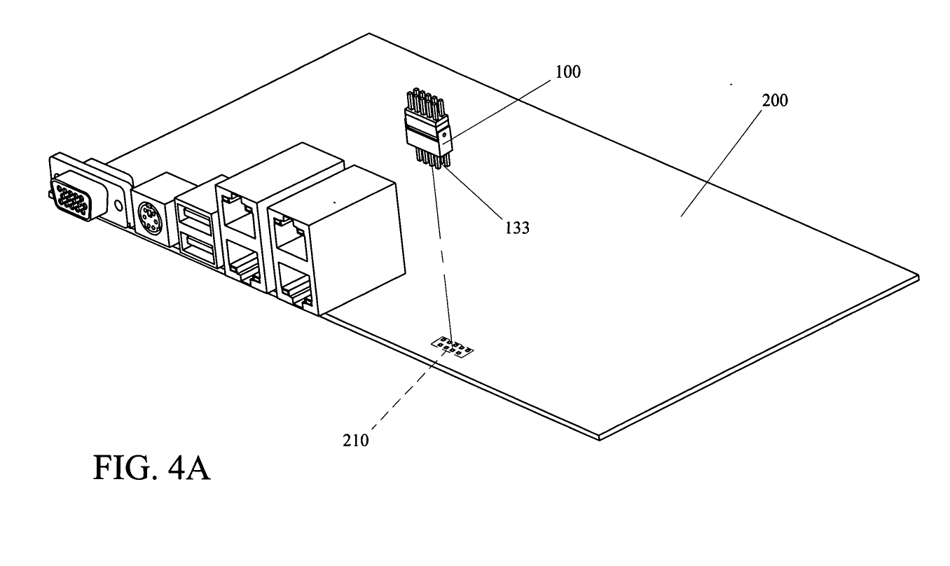

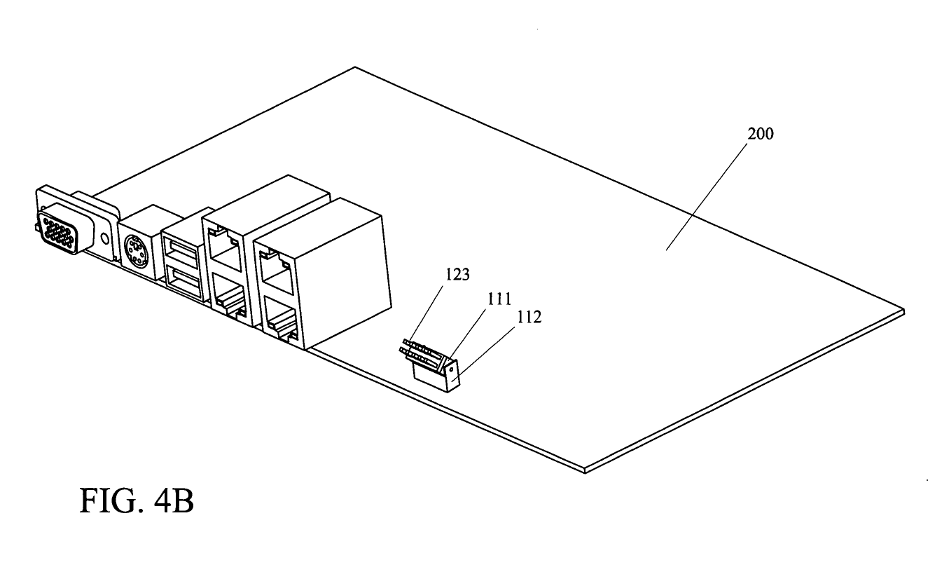

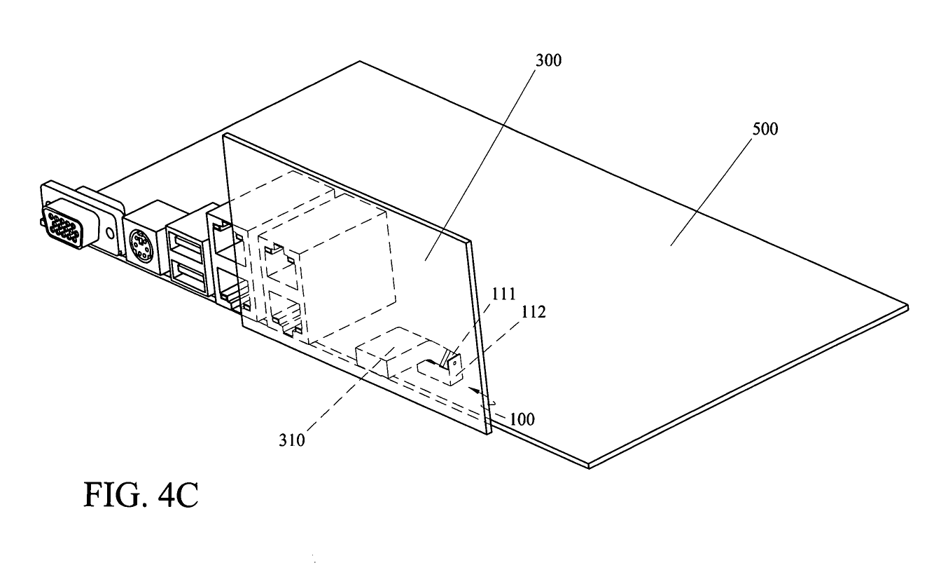

Please refer to FIG. 1 for the three-dimensional exploded view of a first embodiment of the converter according to the invention. The converter 100 is used for internal conversion between a first circuit board 200 (FIG. 4C) and a second circuit board 300 (FIG. 4C) that have different electrical connection designs. The converter 200 includes: a housing 110, a set of first pins 120, a set of second pins 130, and a pivotal axis 140.

The housing consist of a first housing 111 and a second housing 112. It can rotate with respect to the pivotal axis 140. The first housing 111 is formed by covering a first assembly housing 113 on a second assembly housing 114. The first assembly housing 113 is fixed to the second assembly housing 114 by screwing, engaging, or buckling. These means are only examples of the invention, and should not be used to restrict the scope thereof. The first assembly housing 113 further has several first configuring holes 115, and the second housing 112 has several second configuring holes 116. The housing 110, the first housing 111, the second housing 112, the first assembly housing 113, and the second assembly housing 114 are made of an insulating material, such as polycarbonate, polyphthalamide (PPA) or some thermal plastic resin that is commonly used as housing. It should be emphasized that these are only examples of the invention.

The configuring holes 115 on the first assembly housing 113 and the second configuring holes 116 on the second housing 112 are configured according to the first electrical connection specification and the second electrical connection specification, respectively. That is, the number of the first configuring holes 115 and the number of the second configuring holes 116 are different. As shown in the drawing, the first configuring holes 115 are for the 10 pins in the 2.45 standard pin headers (i.e., the first electrical connection specification). The second configuring holes 116 are for the DB9 pins in the RS232 serial bus (i.e., the second electrical connection specification). These are only two examples of different electrical connection specifications. The invention is not limited to these possibilities.

The set of first pins 120 consist of a first inner electrical connection element 121 and a first outer electrical connection element 122, forming an electrical connection between them. The first inner electrical connection element 121 is disposed in the second assembly housing 114. As shown in FIG. 1, the first inner electrical connection element 121 has a bending part 1211, with which the first inner electrical connection element 121 is disposed in the second assembly housing 114. This is only an example, and should not be used to restrict the scope of the invention. The first outer electrical connection element 122 protrudes from the first electrical connections 115. That is, the first outer electrical connection element 122 is disposed in the first assembly housing 113 according to the first electrical connection specification, thereby forming the first electrical connection interface 123. The first electrical connection interface 123 (i.e., the first outer electrical connection element 122) forms an electrical connection with the second circuit board 300.

The electrical connection between the first outer electrical connection element 122 and the first inner electrical connection element 121 can be achieved by directly disposing the first outer electrical connection element 122 on the first configuring holes 115 of the first assembly housing 113 while ejection-forming the first assembly housing 113. The first electrical connection interface 123 is formed at this moment. The first outer electrical connection element 122 can be fixed on the first assembly housing 113. When the first assembly housing 113 covers and fixes onto the second assembly housing 114, the first outer electrical connection element 122 and the first inner electrical connection element 121 are in touch with each other to form an electrical connection. Alternatively, the first outer electrical connection element 122 is fixed by soldering onto the first inner electrical connection element 121, so that the first outer electrical connection element 122 and the first inner electrical connection element 121 are integrally connected electrically. This is only an example, and should not be used to restrict the scope of the invention.

The set of first pins 120, the first inner electrical connection element 121, and the first outer electrical connection element 122 are made of materials with good electrical conductivity, such as copper and iron. These are only an example, and should not be used to restrict the scope of the invention.

The set of second pins 130 has a second inner electrical connection end 131 and a second outer electrical connection end 132. The second inner electrical connection end 131 is disposed in the second housing 112. The second outer electrical connection end 132 protrudes from the second configuring holes 116 of the second housing 112. That is, the second outer electrical connection end 132 is disposed in the second housing 112 according to the second DC specification, thereby forming a second electrical connection interface 133. The second electrical connection interface 133 (i.e., the second outer electrical connection end 132) is used to form an electrical connection with the first circuit board 200. The second inner electrical connection end 131 forms an electrical connection with the first inner electrical connection element 121 according to the electrical connection specification in the housing 100. The second electrical connection end 131 and the first electrical connection element 121 are electrically connected by contact. This only serves as an example, and should not be used to restrict the scope of the invention.

The set of second pins 130 are made of a material of good conductivity, such as copper and iron. These examples should not be used to restrict the scope of the invention.

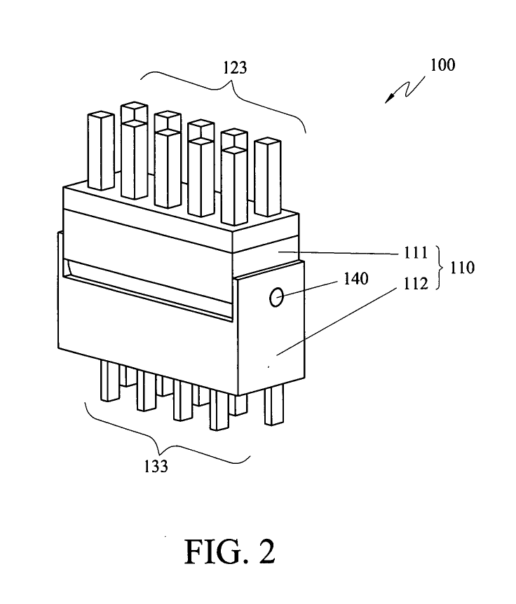

The pivotal axis 140 penetrates through the second assembly housing 114, the second housing 112, the first inner electrical connection element 121, and the second inner electrical connection end 131 to form the pivotal connection of the housing 110, the set of first pins 120, and the set of second pins 130. This constitutes the disclosed converter 100. The converter 100 after assembly is shown in FIG. 2, which is a three-dimensional exploded view of the first embodiment.

Through the pivotal connection of the pivotal axis 140 on the second assembly housing 114 and the second housing 112, the first housing 111 can rotate with respect to the second housing 112. The disclosed converter 100 can achieve the internal conversion between different electrical connection specifications. The first outer electrical connection element 122 can turn to a different direction to form the electrical connection with the second circuit board 300.

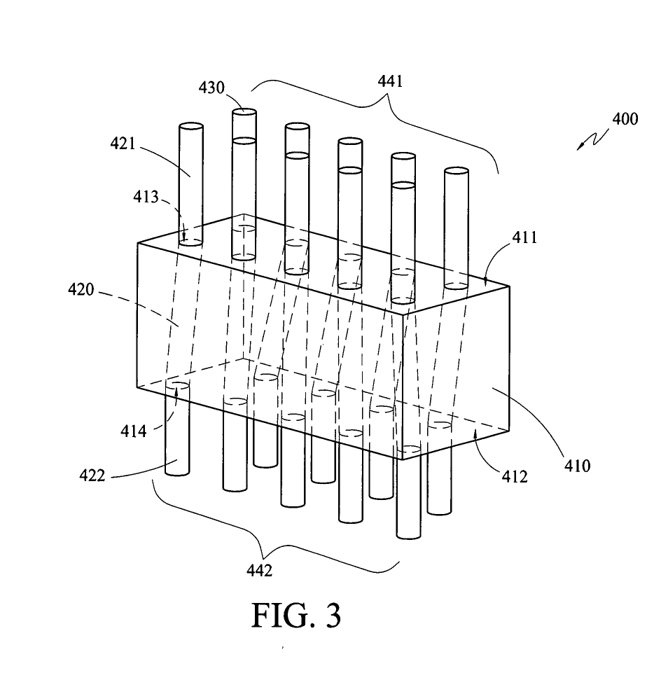

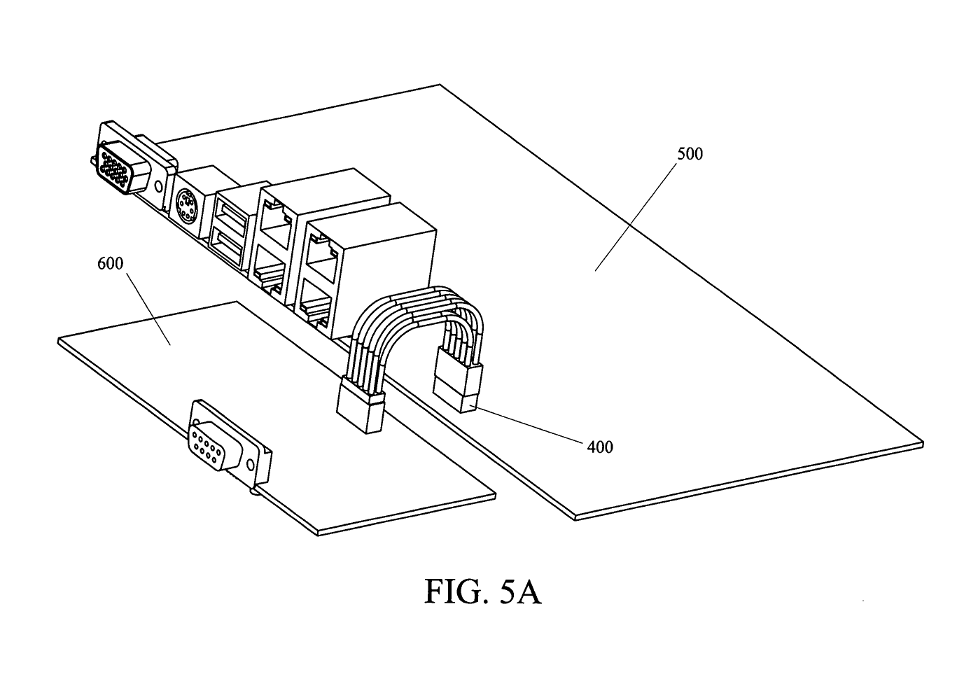

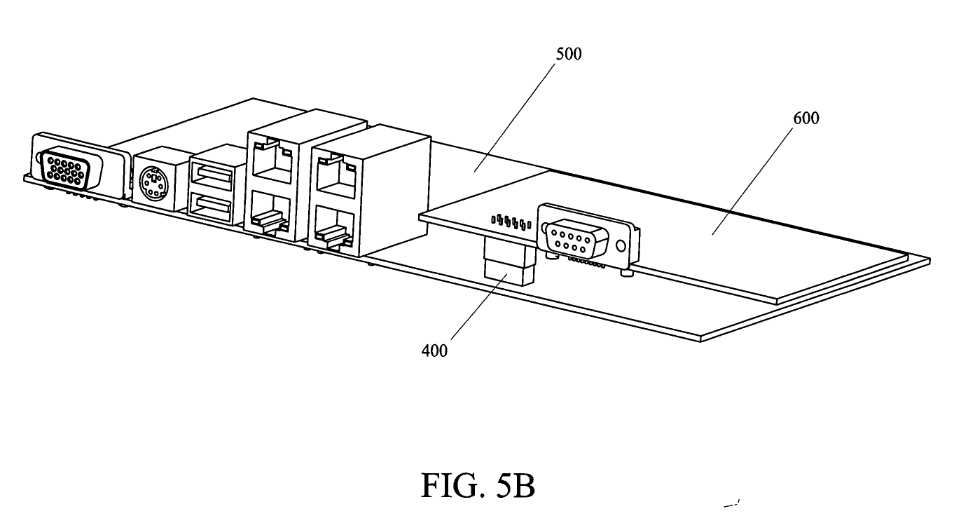

Please refer to FIG. 3, which is a three-dimensional perspective view of a second embodiment of the disclosed converter. The converter 400 can perform internal conversion between a first circuit board 500 (FIG. 5A or 5B) and a second circuit board 600 (FIG. 5A or 5B). It includes: a housing 410, a set of first pins 420, and a set of second pins 430.

The housing 410 is made of an insulating material, such as PC, PPA, or some other resin commonly used for housing 410. These are only examples, and should not be used to restrict the scope of the invention. The housing 410 has a first surface 411 and a second surface 412. The first surface 411 is formed with several first configuring holes 413, and the second surface 412 is formed with several second configuring holes 414. The first configuring holes 413 on the first surface 411 and the second configuring holes 414 on the second surface 412 are formed according to the first electrical connection specification and the second electrical connection specification, respectively. That is, the number of the first configuring holes 413 and the number of the second configuring holes 414 are different.

As shown in the drawing, the first configuring holes 413 are for the 10 pins in the 2.45 standard pin headers (i.e., the first electrical connection specification). The second configuring holes 414 are for the DB9 pins in the RS232 serial bus (i.e., the second DC specification). These are only two examples of different electrical connection specifications. The invention is not limited to these possibilities.

The set of first pins 420 has a first end 421 and a second end 422. The set of first pins 420 are partly enclosed in the housing 410. The first end 421 of the set of first pins 420 protrudes from the first configuring holes 413. The second end 422 of the set of first pins 420 protrudes from the second configuring holes 414.

The set of second pins 430 can selectively protrude from the first configuring holes 413, forming a first electrical connection interface 441 that is electrically connected with the second circuit board 600 via the set of first pins 420 on the first end 421. The set of first pins 420 on the second end 422 forms a second electrical connection interface 442 that is electrically connected with the first circuit board 500. Alternatively, the set of second pins 430 can selectively protrude from the second configuring holes 414, forming a second electrical connection interface 442 that is electrically connected with the first circuit board 500 via the set of first pins 420 on the second end 422. The set of first pins 420 on the first end 421 forms a first electrical connection interface 441 that is electrically connected with the second circuit board 600.

The first electrical connection interface 441 and the second electrical connection interface 442 are determined according to the first electrical connection specification and the second electrical connection specification that are mutually different. As shown in FIG. 3, the set of first pins 420 on the first end 421 protrudes from the first configuring holes 413. The first configuring holes 413 are formed according to the 10 pins of the 2.45 standard pin header. Therefore, the set of second pins 430 protrudes from the first configuring holes 413. The set of second pins 430 and the set of first pins 420 on the first end 421 form the first electrical connection interface 441, which is then electrically connected with the second circuit board 600. The set of the first pins 420 on the second end 422 protrudes from the second configuring holes 414. The second configuring holes 414 are formed according to the DB9 pins of the RS232 serial bus. The set of first pins 420 on the second end 422 can form the second electrical connection interface 442, which is then electrically connected with the first circuit board 500. This achieves the internal conversion between different electrical connection specifications.

The set of first pins 420 and the set of second pins 430 are made of materials of good electrical conductivity, such as copper and iron. These only serve as examples of the invention and should not be used to restrict the scope thereof.

Please simultaneously refer to FIGS. 4A, 4B, and 4C. They show the actions of the first embodiment in use.

The first circuit board 200 can be a motherboard or an expansion board. The second circuit board 300 can be an expansion board or an expansion device. These are only examples of the invention, and should not be used to limit the scope thereof.

As shown in FIG. 4A, the second electrical connection interface 133 of the converter 100 is fixed on an electrical connection part 210 of the first circuit board 200. The second electrical connection interface 133 of the converter 100 and the electrical connection part 210 of the first circuit board 200 are in the electrical connection specification of the DB9 pins of the RS232 serial bus. This embodiment of the electrical connection part 210 of the first circuit board 200 should not be used to restrict the scope of the invention. Fixing the converter 100 on the electrical connection part 210 of the first circuit board 200 is the most common method. The invention is not limited by that. The result of fixing the converter 100 to the electrical connection part 210 of the first circuit board 200 is shown in FIG. 4B.

The first housing 111 and the second housing 112 can rotate with respect to each other. As shown in FIG. 4B, the first housing 111 and the first electrical connection interface 123 differ by 45 degrees. The first housing 111 can rotate an appropriate angle with respect to the second housing 112. The drawing only shows one example. The invention is not limited to such examples.

Please refer to FIG. 4C. The first housing 111 of the converter 100 111 and the first electrical connection interface 123 are rotated with respect to each other by 45 degrees (see FIG. 4B). The first electrical connection interface 123 complies with the electrical connection specification of the 10 pins of the 2.45 standard pin header. This is only one embodiment of the first electrical connection interface 123, and should not be used to restrict the scope of the invention. The electrical connection part 310 of the second circuit board 300 also complies with the electrical connection specification of the 10 pins of the 2.45 standard pin header. The electrical connection part 310 of the second circuit board 300 is connected and fixed to the first electrical connection interface 123 of the converter 100. Thus, the converter 100 establishes an electrical connection between the first circuit board 200 and the second circuit board 300. The disclosed converter 100 can achieve the conversion between different electrical connection specifications. The drawing shows an embodiment for a motherboard and an expansion device. This should not be used to restrict the scope of the invention. In fact, the motherboard can form an electrical connection with the expansion board (not shown) inside, thereby achieving the internal conversion of different electrical connection specifications.

Please simultaneously refer to FIGS. 5A and 5B. FIG. 5A is a three-dimensional view of the second embodiment in its first state. FIG. 5B is a three-dimensional view of the second embodiment in its second state.

The first circuit board 500 can be a motherboard or an expansion board. The second circuit board 600 can be an expansion board or an expansion device. These are only examples of the invention, and should not be used to restrict the scope thereof.

The electrical connection in the second embodiment has been described before and is not repeated here. As shown in FIG. 5A, the second electrical connection interface (not shown) of the disclosed converter 400 needs to be fixed on the electrical connection part (not shown) of the first circuit board 500. The first electrical connection interface (not shown) of the converter 100 forms an electrical connection with the second circuit board 600. Suppose the second electrical connection interface of the converter 400 is for the DB9 pins of the RS232 serial bus, and is fixed on the first circuit board 500. The first electrical connection interface of the converter 400 is for the 10 pins of the 2.45 standard pin header. The second circuit board 600 is directly fixed on the first electrical connection interface of the converter 400. Therefore, the disclosed converter 400 can achieve the internal conversion of different electrical connection specifications.

As shown in FIG. 5B, the second electrical connection interface (not shown) of the disclosed converter 400 needs to be fixed on a first circuit board 500. The first electrical connection interface (not shown) of the converter 100 can form an electrical connection with the second circuit board 600. Suppose the second electrical connection interface of the converter 400 is for the DB9 pins of the RS232 serial bus, and is fixed on the first circuit board 500. The first electrical connection interface of the converter 400 is for the 10 pins of the 2.45 standard pin header. The second circuit board 600 is fixed on the first electrical connection interface of the converter 400 via a bus line. This is another use of the converter 400. Therefore, the disclosed converter 400 can achieve the internal conversion of different electrical connection specifications.

In summary, the invention differs from the prior art in that the invention provides the internal conversion between different circuit boards of different electrical connection specifications. The first electrical connection specification of the converter is fixed on the first circuit board. It is connected to the second circuit board via the second electrical connection specification of the converter, so that the second circuit board is electrically connected to the first circuit board. That is, the converter expands the first circuit board to the second circuit board. This achieves the goal of connecting circuit boards of different electrical connection specifications and expanding the functions thereof.

This technique solves the problem of the first circuit board and the second circuit board with different electrical connection specifications in the IPC. It avoids the difficulty of connecting the first circuit board and the second circuit board. Therefore, circuit boards of different electrical connection specifications can be connected and the functions of the circuit boards can be expanded.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A converter for internal conversion between a first circuit board and a second circuit board of different electrical connection specifications, comprising:
a housing, which is composed of a first housing and a second housing, the first housing consisting of a first assembly housing covering a second assembly housing, the first assembly housing including a plurality of first configuring holes, and the second assembly housing including a plurality of second configuring holes;
a set of first pins, which has a first electrical connection interface and consists a first inner electrical connection element and a first outer electrical connection element, the first inner electrical connection element being disposed in the second assembly housing, the first outer electrical connection element protruding from the configuring holes, and the first outer electrical connection element forming an electrical connection with the second circuit board;
a set of second pins, which has a second electrical connection interface and has a second inner electrical connection end and a second outer electrical connection end, the second inner electrical connection end being disposed in the second housing, the second outer electrical connection end protruding from the second configuring holes, the second outer electrical connection end forming an electrical connection with the first circuit board, and the second inner electrical connection end forming an electrical connection with the first inner electrical connection element according to the electrical connection specifications inside the housing; and
a pivotal axis, which penetrates through the second assembly housing, the second housing, the first inner electrical connection element, and the second inner electrical connection end for the second housing to rotate with respect to the first housing.

2. The converter of claim 1, wherein the set of first pins and the set of second pins are made of materials with good electrical conductivity.

3. The converter of claim 1, wherein the housing is made of an insulating material.

4. The converter of claim 1, wherein the first circuit board is a motherboard or an expansion circuit board.

5. The converter of claim 1, wherein the second circuit board is an expansion circuit board or an expansion device.

6. The converter of claim 1, wherein the first configuring holes are formed on the first assembly housing according to the first electrical connection specification.

7. The converter of claim 1, wherein the second configuring holes are formed on the second housing according to the second electrical connection specification.

8. The converter of claim 1, wherein the number of the first configuring holes and the number of the second configuring holes are different.

9. A converter for internal conversion between a first circuit board and a second circuit board of different electrical connection specifications, comprising:
a housing, which has a first surface and a second surface, the first surfacing having a plurality of first configuring holes and the second surface having a plurality of second configuring holes;
a set of first pins, which has a first end and a second end and is partly enclosed by the housing, the first end protruding from the first configuring holes and the second end protruding from the second configuring holes; and
a set of second pins, which selectively protrudes from the first configuring holes to form a first electrical connection interface electrically connected with the second circuit board with the first end of the set of first pins, with the second end of the set of first pins forming a second electrical connection interface electrically connected with the first circuit board, or protrudes from the second configuring holes to form a second electrical connection interface electrically connected with the first circuit board with the second end of the set of first pins, with the first end of the set of first pints forming a first electrical connection interface electrically connected with the second circuit board.

10. The converter of claim 9, wherein the set of first pins and the set of second pins are made of materials with good electrical conductivity.

11. The converter of claim 9, wherein the housing is made of an insulating material.

12. The converter of claim 9, wherein the first circuit board is a motherboard or an expansion circuit board.

13. The converter of claim 9, wherein the second circuit board is an expansion circuit board or an expansion device.

14. The converter of claim 9, wherein the first configuring holes are formed on the first assembly housing according to the first electrical connection specification.

15. The converter of claim 9, wherein the second configuring holes are formed on the second housing according to the second electrical connection specification.

16. The converter of claim 9, wherein the number of the first configuring holes and the number of the second configuring holes are different.
